(19) United States
(12) Patent Application Publication
(10) Pub. No.: US 2024/0343953 A1
(43) Pub. Date: Oct. 17, 2024

(54) ADHESIVE, FUEL CELL, AND METHOD FOR MANUFACTURING FUEL CELL

(71) Applicant: TOYOTA JIDOSHA KABUSHIKI KAISHA, Toyota-shi (JP)

(72) Inventors: Kohsuke OHMI, Nagoya-shi (JP); Takahiro INATOMI, Nagoya-shi (JP); Akihito MORIYA, Nagoya-shi (JP)

(73) Assignee: TOYOTA JIDOSHA KABUSHIKI KAISHA, Toyota-shi (JP)

(21) Appl. No.: 18/620,030

(22) Filed: Mar. 28, 2024

(30) Foreign Application Priority Data
Apr. 13, 2023 (JP) 2023-065530

(51) Int. Cl. C09J 153/02; C09J 7/30; H01M 8/2465

(52) U.S. Cl. CPC C09J 153/02; C09J 7/30; H01M 8/2465; C09J 2203/33; C09J 2453/00

(57) ABSTRACT

Provided is an adhesive having high adhesive capacity even in the high temperature water, a fuel cell having the adhesive, and a method for manufacturing the fuel cell. An adhesive includes a base polymer, a tackifier, and an acid modified polypropylene. The acid modified polypropylene is at least one of the acid modified polypropylene selected from maleic anhydride-modified polypropylene and maleic acid-modified polypropylene. A mass ratio of the acid modified polypropylene to the base polymer (acid modified polypropylene/base polymer) is 0.1 or more.

### CROSS REFERENCE TO RELATED APPLICATIONS

The present application claims priority from Japanese patent application JP 2023-065530 filed on Apr. 13, 2023, the entire content of which is hereby incorporated by reference into this application.

### BACKGROUND

### Technical Field

The present disclosure relates to an adhesive, a fuel cell, a method for manufacturing the fuel cell.

### Background Art

A fuel cell is supplied with, for example, hydrogen, air, and cooling water between cells of fuel cell for generating electricity. In order to suppress these substances from leaking, it is necessary to seal between the cells of fuel cell. To seal between the cells of fuel cell, a rubber gasket is widely used. Since the gasket is usually made from a thermosetting material, the production of the fuel cell requires a long time.

JP 2022-61158 A discloses an adhesive film that includes a substrate film and an adhesive layer formed on at least one surface of the substrate film, in which the adhesive layer is formed of an adhesive composition containing (meth)acrylic copolymer obtained from living radical polymerization, the (meth)acrylic copolymer includes a structural unit (a-1) having a cyclic ether group and a structural unit (a-2) having an acidic group, and has a molecular weight distribution (Mw/Mn) of 3.0 or less and a gel fraction of the adhesive layer of 30 mass % or more. The adhesive film disclosed in JP 2022-61158 A has the cyclic ether group, such as an epoxy group, and thus, a high temperature heating process has been required to exert a sufficient adherence property.

### SUMMARY

The inventors have examined to join between the cells of fuel cell at high speed using a pressure-sensitive adhesive instead of the gasket. However, they have found that a general pressure-sensitive adhesive has a low adhesive strength in an environment where the cell of fuel cell is used, such as in high temperature water.

The present disclosure provides an adhesive having a high adhesive capacity even in the high temperature water, a fuel cell having the adhesive, and a method for manufacturing the fuel cell.

The inventors have reached the present disclosure through intensive research to solve the above-described problem by finding that an adhesive including a certain amount of a certain acid modified polypropylene with respect to a base polymer has a high adhesive strength even in the high temperature water.

Exemplary aspects of the embodiments are described as follows.
(1) An adhesive comprising: a base polymer; a tackifier; and an acid modified polypropylene, wherein the acid modified polypropylene is at least one of the acid modified polypropylene selected from maleic anhydride-modified polypropylene and maleic acid-modified polypropylene, and wherein a mass ratio of the acid modified polypropylene to the base polymer (acid modified polypropylene/base polymer) is 0.1 or more.
(2) The adhesive according to (1), wherein the adhesive has a sheet shape.
(3) A fuel cell comprising the adhesive according to (1) or (2) arranged between cells of fuel cell.
(4) A method for manufacturing a fuel cell comprising: arranging an adhesive between cells of fuel cell, and adhering the cells of fuel cell by applying a pressure,
   wherein the adhering is performed at a temperature of 23° C. to 95° C.,
   wherein the adhesive includes a base polymer, a tackifier, and an acid modified polypropylene,
   wherein the acid modified polypropylene is at least one of the acid modified polypropylene selected from maleic anhydride-modified polypropylene and maleic acid-modified polypropylene, and
   wherein a mass ratio of the acid modified polypropylene to the base polymer (acid modified polypropylene/base polymer) is 0.1 or more.
(5) The method for manufacturing the fuel cell according to (4), wherein the adhering is performed at a temperature of 30° C. to 95° C.

The present disclosure allows providing an adhesive having a high adhesive capacity even in high temperature water, a fuel cell having the adhesive, and a method for manufacturing the fuel cell.

### BRIEF DESCRIPTION OF THE DRAWINGS

FIG. 1 illustrates peel strength in high temperature water of Material 2 and Material 3.

### DETAILED DESCRIPTION

The following describes an adhesive, a fuel cell, and a method for manufacturing the fuel cell according to the embodiment in detail. The adhesive according to the embodiment includes a base polymer, a tackifier, and an acid modified polypropylene, in which the acid modified polypropylene is at least one of the acid modified polypropylene selected from maleic anhydride-modified polypropylene and maleic acid-modified polypropylene, and a mass ratio of the acid modified polypropylene to the base polymer (acid modified polypropylene/base polymer) is 0.1 or more.

### (Base Polymer)

The base polymer is not specifically limited as long as it is allowed to be used as a base polymer of an adhesive, such as a conventionally-known polymer. Examples of the base polymer include, for example, a styrene polymer, an acrylic polymer, a rubber polymer, a polyester polymer, a urethane polymer, a polyether polymer, a silicone polymer, and the like. In some embodiments, the base polymer is at least one of the base polymer selected from the styrene polymer, the acrylic polymer, and the rubber polymer. The base polymer may be used alone or in combinations of two or more. The base polymer may be a block copolymer of a monovinyl compound and a conjugated diene compound.

Examples of the styrene polymer include a styrene block copolymer. For the styrene block copolymer, for example, a styrene-isoprene-styrene block copolymer and styrene-butadiene-styrene block copolymer are allowed to be used. For the styrene block copolymer, the styrene content may be 50 mass % or less, and 40 mass % or less in some embodiments. The styrene content means an amount (mass %) of constituent units derived from styrene in 100 mass % of the copolymer.

Examples of the acrylic polymer include, for example, a polymer with a main constituent unit of a constituent unit derived from alkyl(meth)acrylate. The main constituent unit means a constituent unit exceeding 50 mass % in 100 mass % of the polymer.

The alkyl(meth)acrylate is alkyl(meth)acrylate expressed by the following general formula (1) in some embodiments.

CH₂═C(R¹)COOR² (1)

Here, R¹ in the above-described formula (1) is a hydrogen atom or a methyl group, and R² is an alkyl group having 1 to 20 carbon atoms.

The acrylic polymer may have a constituent unit other than the constituent unit derived from alkyl(meth)acrylate. Examples of the constituent unit other than the constituent unit derived from alkyl(meth)acrylate include a constituent unit derived from a functional group-containing monomer, such as a carboxy group-containing monomer, a hydroxyl group-containing monomer, an acid anhydride group-containing monomer, and an amido group-containing monomer.

Examples of the rubber polymer include, for example, rubbers other than the styrene polymer, and may be a natural rubber or may be a synthetic rubber. Examples of the synthetic rubber include, for example, polyisoprene, polybutadiene, polyisobutylene, and butyl rubber.

### (Tackifier)

The tackifier is not specifically limited as long as it is allowed to be used as a tackifier, such as a conventionally-known tackifier. Examples of the tackifier include, for example, a rosin-based resin, a terpene-based resin, petroleum-based resin, a coumarone-indene resin, an alkylphenol resin, a xylene resin, and the like. The tackifier is at least one of the tackifier selected from the rosin-based resin, the terpene-based resin, and the petroleum-based resin in some embodiments. The tackifier may be used alone or in combinations of two or more.

Examples of the rosin-based resin include, for example, rosin, hydrogenated rosin, rosin ester, hydrogenated rosin ester, rosin phenolic resin, and polymerized rosin.

Examples of the terpene-based resin include, for example, a terpene resin, a terpene phenol resin, an aromatic modified terpene resin, or a hydrogenated terpene resin.

Examples of the petroleum-based resin include, for example, an aliphatic petroleum resin, a hydrogenated petroleum resin, an alicyclic petroleum resin, an aromatic petroleum resin, and a copolymerized petroleum resin.

### (Acid Modified Polypropylene)

The acid modified polypropylene is at least one of the acid modified polypropylene selected from the maleic anhydride-modified polypropylene and the maleic acid-modified polypropylene.

The maleic anhydride-modified polypropylene is a polymer obtained by denaturing polypropylene with maleic anhydride, and the maleic acid-modified polypropylene is a polymer obtained by denaturing polypropylene with maleic acid. The denaturation method is not specifically limited, and a known method may be used. For example, examples include a method in which polypropylene is dissolved in a solvent, is added with a polar monomer and a radical precursor, and is heated and stirred, a method in which the above-described respective components are supplied to an extruder to be graft-copolymerized, and a solid phase denaturation method.

A constituent unit amount (for example, a graft amount) derived from the polar monomer in the acid modified polypropylene is 0.1 mass % or more in some embodiments, 0.3 mass % or more in some embodiments, 0.5 mass % or more in some embodiments, 20 mass % or less in some embodiments, 15 mass % or less in some embodiments, and 10 mass % or less in some embodiments. The above-described constituent unit amount is obtainable from, for example, infrared absorption spectroscopy.

The maleic anhydride-modified polypropylene may have a structure derived from those other than propylene or maleic anhydride, such as a structure derived from at least one selected from ethylene, olefin having 4 to 6 carbon atoms, and maleic acid. The maleic acid-modified polypropylene may have a structure derived from those other than propylene or maleic acid, such as a structure derived from at least one selected from ethylene, olefin having 4 to 6 carbon atoms, and maleic anhydride.

### (Adhesive)

The adhesive according to the embodiment includes the above-described base polymer, tackifier, and acid modified polypropylene. The mass ratio of the acid modified polypropylene to the base polymer (acid modified polypropylene/base polymer) included in the adhesive is 0.1 or more. The mass ratio of the acid modified polypropylene to the base polymer (acid modified polypropylene/base polymer) may be 0.5 or less or may be 0.4 or less. The above-described range enables the adhesive to exert a high adhesive capacity even under a high temperature condition, such as in high temperature water in some embodiments.

The mass ratio of the tackifier to the base polymer (tackifier/base polymer) included in the adhesive is, for example, 0.7 to 1.3, or may be 0.8 to 1.2.

The adhesive may have any shape not specifically limited. For example, the adhesive without having a predetermined shape may be applied and used. The adhesive may be in a sheet shape. When it is in a sheet shape, the adhesive is allowed to be used as an adhesive sheet. The sheet-shaped adhesive has for example, a thickness of 50 to 300 μm in some embodiments.

The adhesive may include a component other than the base polymer, the tackifier, and the acid modified polypropylene, such as an additive. Examples of the additive include, for example, a crosslinking agent, a plasticizer, a filler, an anti-aging agent, a conductive material, a release modifier, a softener, a surfactant, a flame retardant, an antioxidant, a solvent, and the like. The additive in a range of, for example, 0.1 to 30 mass % is included in 100 mass % of an adhesive.

A preparation method of the adhesive is not specifically limited, and, for example, mixing the above-described respective raw materials with a kneading machine, such as a twin-screw kneader, enables obtaining the adhesive. For example, processing the adhesive obtained by the mixing into a sheet shape by a method, such as press forming, and performing cutting, punching, and the like on it as necessary to form into a desired shape enables obtaining a sheet-shaped adhesive, that is, an adhesive sheet.

### (Fuel Cell)

The fuel cell according to the embodiment is provided with the above-described adhesive arranged between the cells of fuel cell. The fuel cell is only necessary to be provided with the above-described adhesive arranged between the cells of fuel cell, and other members are not specifically limited.

The cell of fuel cell has a part in contact with the adhesive, that is, an adhered body. The material of the adhered body is at least one selected from stainless steel, titanium, and aluminum from the aspect of adhesive strength in some embodiments.

The cells of fuel cell constituting the fuel cell are at least two or more, and the above-described adhesive is arranged between the cells of fuel cell and the adhesive adheres between the cells. The above-described adhesive has the high adhesive capacity even in the high temperature water, thereby enabling stable use of the fuel cell. In the fuel cell, the cells of fuel cell are generally stacked in series. The number of stacks is, for example, 2 to 400, and is 50 to 370 in some embodiments, and 70 to 340 in some embodiments.

### (Method for Manufacturing Fuel Cell)

The method for manufacturing the fuel cell according to the embodiment includes a step of arranging the adhesive between the cells of fuel cell and adhering the cells of fuel cell by applying a pressure, the step is performed at a temperature of 23° C. to 95° C., the adhesive includes the base polymer, the tackifier, and the acid modified polypropylene, the acid modified polypropylene is at least one of the acid modified polypropylene selected from the maleic anhydride-modified polypropylene and the maleic acid-modified polypropylene, and the mass ratio of the acid modified polypropylene to the base polymer (acid modified polypropylene/base polymer) is 0.1 or more. That is, in the method for manufacturing the fuel cell, the adhesive according to the embodiment described above is used. The method for manufacturing the fuel cell is only necessary to have the above-described step, and the other steps are not specifically limited.

The method for arranging the adhesive between the cells of fuel cell may be performed by applying the adhesive on the cells of fuel cell or may be performed by arranging the adhesive sheets between the cells of fuel cell.

In the above-described step, the pressure is usually 0.5 to 5 MPa and 1 to 3 MPa in some embodiments. In the above-described step, the pressing period is usually 1 to 15 seconds, and 2 to 10 seconds in some embodiments. The above-described step is performed at a temperature of 23° C. to 95° C. Performing the step under the above-described conditions enables adhering between the cells of fuel cell with a sufficient strength. In some embodiments, the temperature is 30° C. to 95° C. from the aspect of adhesive strength stability.

### EXAMPLES

While the following describes the embodiment with examples, the present disclosure is not limited to these examples.

In the examples and comparative example, the following materials were used.
base polymer: Quintac (registered trademark) 3421 (Zeon Corporation),
tackifier: Quintone (registered trademark) M100 (Zeon Corporation),
maleic anhydride-modified polypropylene: Modic P512VB (Mitsubishi Chemical Corporation).

Note that, the maleic anhydride-modified polypropylene in Table 1 is denoted as m-PP.

### Examples and Comparative Example

Quintac (registered trademark) 3421, Quintone (registered trademark) M100, and Modic P512VB were mixed in the combined amount shown in Table 1 using a twin-screw kneader. The obtained mixed material (adhesive) was rolled out to have a thickness of 150 μm with a pressing machine to be formed into a sheet shape. The obtained sheet was sandwiched between two SUS plates of 0.1 mm thickness and was pressed with a pressing machine at a pressure of 3 MPa, for a pressing period of 10 seconds, and at a temperature shown in Table 1 to manufacture an adhesive specimen.

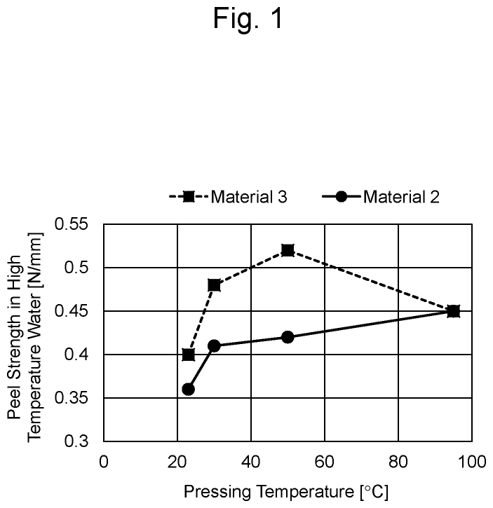

The adhesive specimen was subjected to a peeling test in water of 95° C., and peel strength was calculated. The peel strength is shown in Table 1 as peel strength in a high temperature water. Note that, Material 1 in Table 1 corresponds to the comparative example, Materials 2 and 3 correspond to the examples. FIG. 1 illustrates the peel strength in the high temperature water of Material 2 and Material 3.

TABLE 1

| | Material Composition | | | | Peel Strength |
|---|---|---|---|---|---|
| | Compounding Weight | | | | in High |
| | Ratio [—] | | | Pressing | Temperature |
| | Base | | | Temperature | Water |
| Material | Polymer | Tackifier | m-PP | [° C.] | [N/mm] |
| 1 | 100 | 100 | 0 | 23 | 0.05 |
| 1 | 100 | 100 | 0 | 50 | 0.04 |
| 1 | 100 | 100 | 0 | 95 | 0.07 |
| 2 | 100 | 100 | 10 | 23 | 0.36 |
| 2 | 100 | 100 | 10 | 30 | 0.41 |
| 2 | 100 | 100 | 10 | 50 | 0.42 |
| 2 | 100 | 100 | 10 | 95 | 0.45 |
| 3 | 100 | 100 | 30 | 23 | 0.40 |
| 3 | 100 | 100 | 30 | 30 | 0.48 |
| 3 | 100 | 100 | 30 | 50 | 0.52 |
| 3 | 100 | 100 | 30 | 95 | 0.45 |

From Table 1, it is seen that the adhesives according to the embodiment that include a predetermined amount of the maleic anhydride-modified polypropylene have excellent peel strength in the high temperature water. In view of this, the adhesives according to the embodiment are allowed to be appropriately used when adhering between the cells of fuel cell.

The upper limit value and/or lower limit value of numerical ranges described herein are allowed to have appropriate ranges specified by combining each of them conveniently. For example, the appropriate ranges are allowed to be specified by conveniently combining the upper limit values and the lower limit values of the numerical ranges, the appropriate ranges are allowed to be specified by conveniently combining the upper limit values of the numerical ranges, or the appropriate ranges are allowed to be specified by conveniently combining the lower limit values of the numerical ranges.

While the embodiment has been described in detail, specific configurations are not limited to the embodiment, and when there are changes of designs within the range not departing from the gist of the present disclosure, they are included in the present disclosure.

What is claimed is:

1. An adhesive comprising:
a base polymer;
a tackifier; and
an acid modified polypropylene,
wherein the acid modified polypropylene is at least one of the acid modified polypropylene selected from maleic anhydride-modified polypropylene and maleic acid-modified polypropylene, and
wherein a mass ratio of the acid modified polypropylene to the base polymer (acid modified polypropylene/base polymer) is 0.1 or more.

2. The adhesive according to claim 1,
wherein the adhesive has a sheet shape.

3. A fuel cell comprising the adhesive according to claim 1 arranged between cells of fuel cell.

4. A method for manufacturing a fuel cell comprising:
arranging an adhesive between cells of fuel cell, and adhering the cells of fuel cell by applying a pressure,
wherein the adhering is performed at a temperature of 23° C. to 95° C.,
wherein the adhesive includes a base polymer, a tackifier, and an acid modified polypropylene,
wherein the acid modified polypropylene is at least one of the acid modified polypropylene selected from maleic anhydride-modified polypropylene and maleic acid-modified polypropylene, and
wherein a mass ratio of the acid modified polypropylene to the base polymer (acid modified polypropylene/base polymer) is 0.1 or more.

5. The method for manufacturing the fuel cell according to claim 4,
wherein the adhering is performed at a temperature of 30° C. to 95° C.
